(19) United States
(12) Patent Application Publication
(10) Pub. No.: US 2011/0048166 A1
(43) Pub. Date: Mar. 3, 2011

(54) Bicycle clipless pedal with clamping force adjusting assembly

(75) Inventor: Wen-Hwa Lin, Taichung City (TW)

(73) Assignee: VP Components Co., Ltd.

(21) Appl. No.: 12/584,362

(22) Filed: Sep. 3, 2009

(51) Int. Cl. B62M 3/08; G05G 1/48

(52) U.S. Cl. 74/594.6

(57) ABSTRACT

A bicycle clipless pedal with a clamping force adjusting assembly is disclosed. The clamping force adjusting assembly allows a user to manually change a preload of a compression spring in the pedal so as to adjust a clamping force provided by a rear clamping set of the bicycle clipless pedal to a shoe cleat.

### BACKGROUND OF THE INVENTION

1. Technical Field

The present invention relates to bicycle clipless pedals and more particularly, to a bicycle clipless pedal equipped with a clamping force adjusting assembly so that the clipless pedal is capable of providing an adjustable clamping force to an external shoe cleat.

2. Description of Related Art

A bicycle clipless pedal is designed to removably engage with a cleat of a cleated shoe for fastening a cyclist's foot to the pedal. As compared with the traditional pedals without a cleat retaining structure, the clipless pedals help the cyclist to pedal with less effort, to maintain rotational acceleration of the pedal, and to prevent the his/her feet from coming off from the pedals during his/her riding. For the aforementioned advantages, the clipless pedals have been extensively used in cross country bikes, mountain bikes, and racing bikes.

A known design of a bicycle clipless pedal, as disclosed in U.S. Pat. No. 6,708,584, is a pedal assembly that has a center tubular portion 30, a bicycle pedal 12 rotating around the center tubular portion 30, a front and rear clamping members 24 and 26 fixedly coupled to a first and second ends of the bicycle pedal 12, respectively. The '584 patent also disclosed a cleat 14 for being coupled with the pedal assembly. The cleat 14 has a set of front coupling members 86, 88, and a set of rear coupling members 90, 92, for engaging the front and rear clamping members 24 and 26, respectively. A support pin 28 is coupled to the rear end of the bicycle pedal 12 and a set of torsion springs 29 are mounted on the support pin 28. Therein, one end of the spring 29 is connected with the rear clamping member 26.

The pedal assembly provided by the '584 patent indeed provides due clamping performance at the initial stage of use because at that time the regular springiness of the torsion springs 29 ensures the firm combination between the rear clamping member 26 and the rear coupling members 90, 92. However, with the lapse of use time, fatigue failure happening to the torsion springs 29 can adversely affect the desired combination between the shoe cleat 14 and the pedal 12. As a result, the cleat 14 is likely to come off when the cyclist pedals, risking the cyclist getting muscle strains. Therefore, the '584 patent lacks for a technical approach recovering the desired clamping force the pedal 12 applies to the shoe cleat 14 as a solution to fatigue failure of the torsion springs 29.

### SUMMARY OF THE INVENTION

Hence, the present invention is herein disclosed to provide a bicycle clipless pedal with a clamping force adjusting assembly that solves the problem of the prior art and provides an effective adjusting means to recover the clamping performance of the clipless pedal from a weaken state thereof.

The primary objective of the present invention is to provide a bicycle clipless pedal with a clamping force adjusting assembly, by which adjusting assembly, a user is allowed to adjust a clamping force exerted by a rear clamping set of the pedal.

Another objective of the present invention is to provide a bicycle clipless pedal with a clamping force adjusting assembly, wherein the clamping force adjusting assembly can be easily operated by using a screwdriver to screw or unscrew an adjusting screw so as to adjust a clamping force of the pedal.

To achieve theses and other objectives of the present invention, the bicycle clipless pedal with the clamping force adjusting assembly includes a pedal axle, a pedal body coupled to and rotating around the pedal axle, and a rear clamping set connected to a rear end of the pedal body, wherein the rear clamping set includes: an assembling portion connected to the pedal body; a fastening member pivotally connected to the assembling portion, a compression spring settled in the assembling portion for providing a spring force to abut against the fastening member, and the clamping force adjusting assembly deposited at the assembling portion for adjusting a preload of the compression spring.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawing, wherein:

FIG. 1 is a front oblique view of a bicycle clipless pedal with a clamping force adjusting assembly of the present invention;

FIG. 2 is a rear oblique view of the bicycle clipless pedal of the present invention;

FIG. 3 is an exploded view of the bicycle clipless pedal taken from the same viewpoint of FIG. 2;

FIG. 4 is a sectional assembled view of the bicycle clipless pedal of the present invention;

FIG. 5 shows adjustment of the clamping force adjusting assembly of the bicycle clipless pedal; and

FIGS. 6 through 8 illustrate combination between a shoe cleat and the bicycle clipless pedal of the present invention.

### DETAILED DESCRIPTION OF THE PREFERRED EMBODIMENT

While a preferred embodiment provided hereinafter for illustrating the concept of the present invention as described above, it is to be understood that the components of the embodiment shown in the accompanying drawings are depicted for the sake of easy explanation and need not to be made in scale.

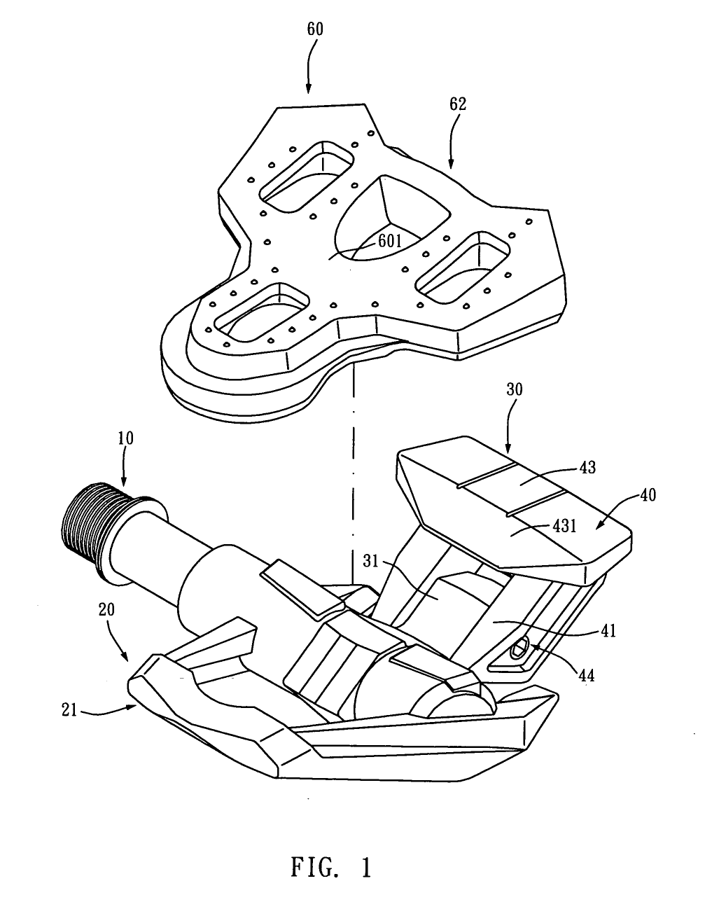

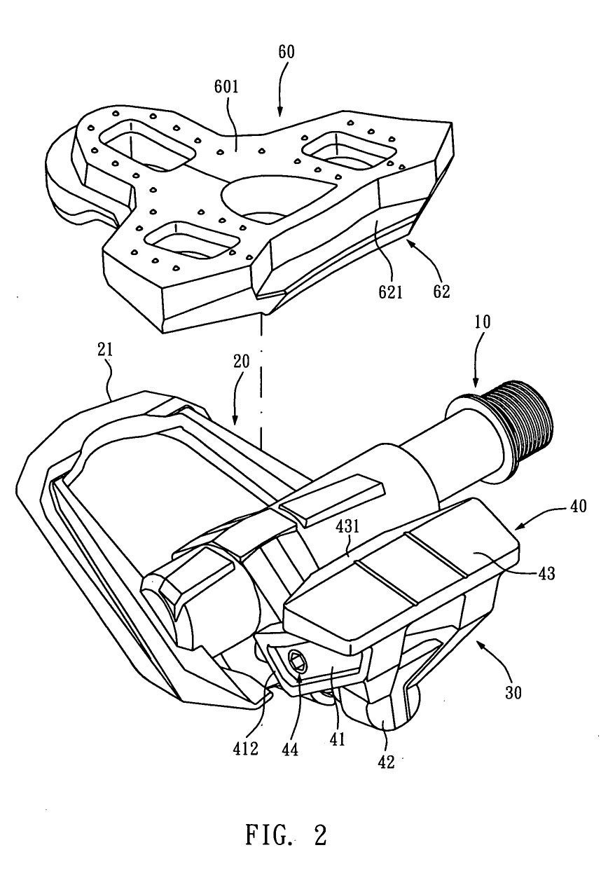

Please refer to FIGS. 1 and 2 for a bicycle clipless pedal with a clamping force adjusting assembly of the present invention. The clipless pedal has a pedal axle 10 coupled with a crank arm (not shown) of a bicycle, a pedal body 20 coupled to and rotating around the pedal axle 10, a front coupling portion 21 provided at a front end of the pedal body 20, and a rear clamping set 30 connected to a rear end of the pedal body 20.

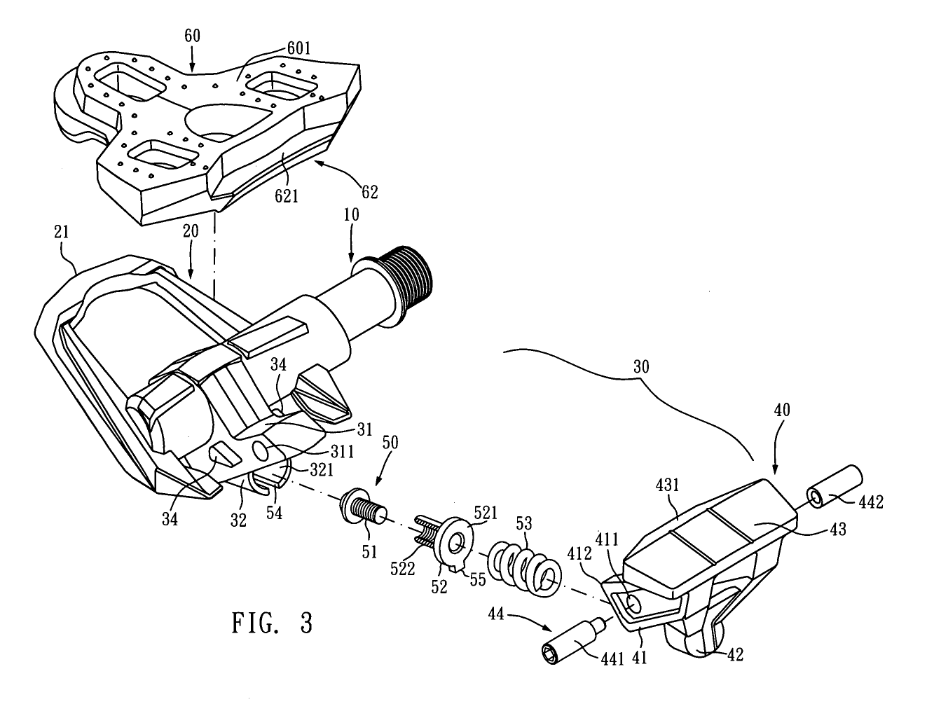

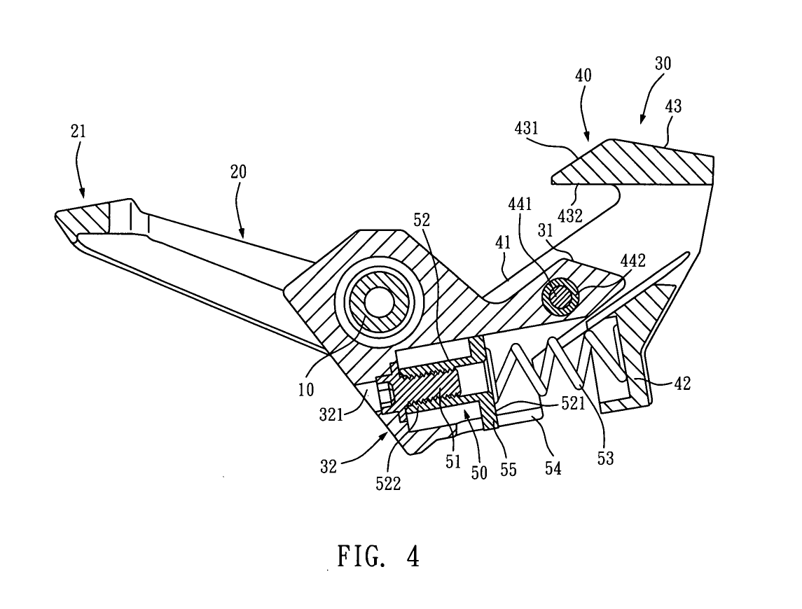

As shown in FIGS. 3 and 4, the rear clamping set 30 includes an assembling portion 31, a fastening member 40, a compression spring 53, and the clamping force adjusting assembly 50.

The assembling portion 31 is connected to the rear end of the pedal body 20. A tubular structure 32 is provided at a bottom of the assembling portion 31 and two retaining blocks 34 flank the assembling portion 31.

The fastening member 40 includes a pivot portion 41, a spring-stop portion 42 connected to a lower edge of the pivot portion 41 and corresponding to an end of the tubular structure 32, and a coupling board 43 connected from above to the pivot portion 41. The pivot portion 41 is formed with a transversely extending through hole 411 for allowing a pin 44 of the assembling portion 31 to pass therethrough, so as to connect the pivot portion 41 with the assembling portion 31 while the fastening member 40 is allowed to change its position angularly around the pin 44. The pivot portion 41 has an open end 412 contacting upper surfaces of the retaining blocks 34. In the present embodiment, the pin 44 includes a first pin part 441 and a second pin part 442 that are axially combined in a tight fit inside a pin hole 311 of the assembling portion 31. Outer ends of the first pin part 441 and the second pin part 442 are received in the through hole 411 of the fastening member 40 so that the fastening member 40 can rotate around the first pin part 441 and the second pin part 442.

The compression spring 53 is settled in the tubular structure 32 and abuts against the spring-stop portion 42 of the fastening member 40.

The clamping force adjusting assembly 50 includes an adjusting screw 51 and an adjusting socket 52. The adjusting socket 52 is settled in the tubular structure 32. A slot 54 and a retaining protuberance 55 are formed on the tubular structure 32 and the adjusting socket 52 positionally corresponding to each other to be coupled mutually for preventing relative rotation between the adjusting socket 52 and the tubular structure 32. The adjusting socket 52 has a first end formed as a spring-stop portion 521. Thereby, two ends of the compression spring 53 abut against the two spring-stop portions 42, 521 respectively. A second end of the adjusting socket 52 is provided with a threaded hole 522 so that the adjusting screw 51 coming through a through hole 321 formed at one end of the tubular structure 32 can get screwedly coupled with the threaded hole 522.

Thereby, a user can reach a head of the adjusting screw 51 with a screwdriver or the like through the through hole 321 of the tubular structure 32, and then adjust the adjusting screw 51. Since the adjusting socket 52 is rotationally restricted in the tubular structure 32, according to the arrangement of the threads on the adjusting screw 51 and in the threaded hole 522, when the adjusting screw 51 is rotated in one direction, the adjusting socket 52 is driven to move toward the compression spring 53, and, on the contrary, when the adjusting screw 51 is rotated in the other direction, the adjusting socket 52 is driven to move away from the compression spring 53. Thus, rotation of the adjusting screw 51 makes the adjusting socket 52 move linearly in the tubular structure 32 and compress or release the compression spring 53, thereby changing a preload of the compression spring 53.

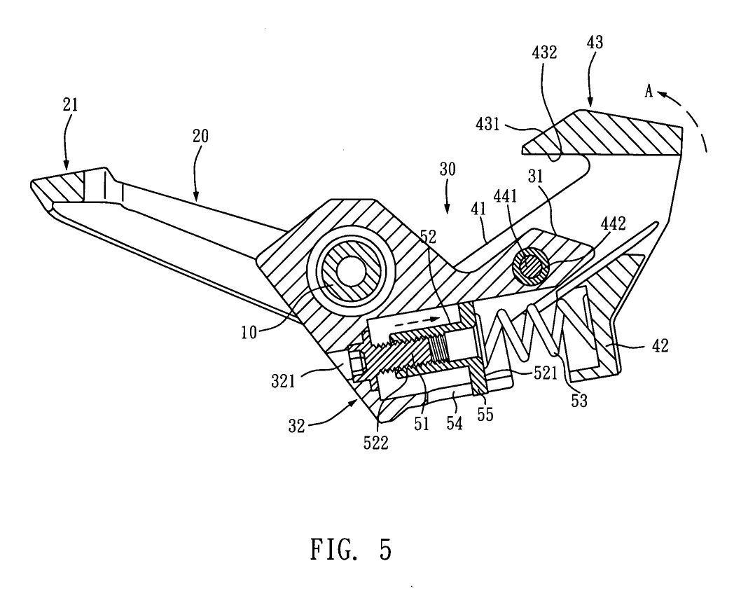

Referring to FIGS. 4 and 5, the above adjustment controlled by rotation of the adjusting screw 51 is illustrated by means of some sectional assembled views of the pedal. Rotation of the adjusting screw 51 makes the adjusting socket 52 move inside the tubular structure 32 toward the compression spring 53. At this time, the compression spring 53 is compressed between the two spring-stop portions 521, 42. As a result, the elastic preload of the compression spring 53 increases, meaning spring-stop portion 42 of the fastening member 40 receives an increased pushing force. The fastening member 40 thus swings around the pin 44 along a direction as indicated by the arrow A, so that the fastening member 40 provides an enhanced clamping force to a rear coupling portion 62 (as shown in FIGS. 1 through 3) of a shoe cleat 60 coupled with the pedal body 20. On the contrary, when the adjusting socket 52 moves away from the compression spring 53, the preload of the compression spring 53 decreases; thereby releasing the clamping force provided by the fastening member 40 to the rear coupling portion 62.

Referring back to FIGS. 1 through 3, the rear coupling portion 62 of the shoe cleat 60 has a horizontal coupling surface 621 depressed from an upper surface 601 of the shoe cleat 60. The coupling board 43 has its upper surface formed with a downward inclined surface 431 and has its lower surface formed as a horizontal coupling surface 432. When the shoe cleat 60 is coupled with the pedal body 20, the horizontal coupling surface 432 of the coupling board 43 and the horizontal coupling surface 621 of the shoe cleat 60 retain mutually.

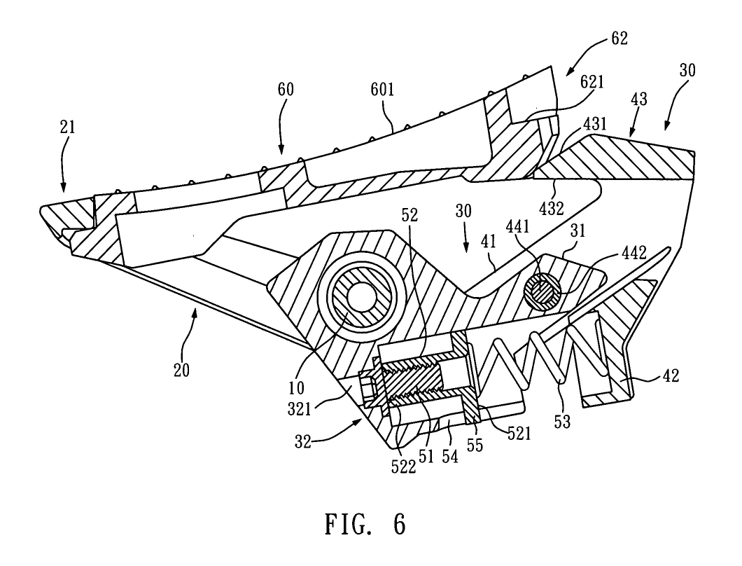

The combination between the shoe cleat 60 and the disclosed clipless pedal is explained below with reference to FIGS. 6, 7, and 8.

As shown in FIG. 6, the shoe cleat 60 has its front end downward reaching a lower surface of the front coupling portion 21.

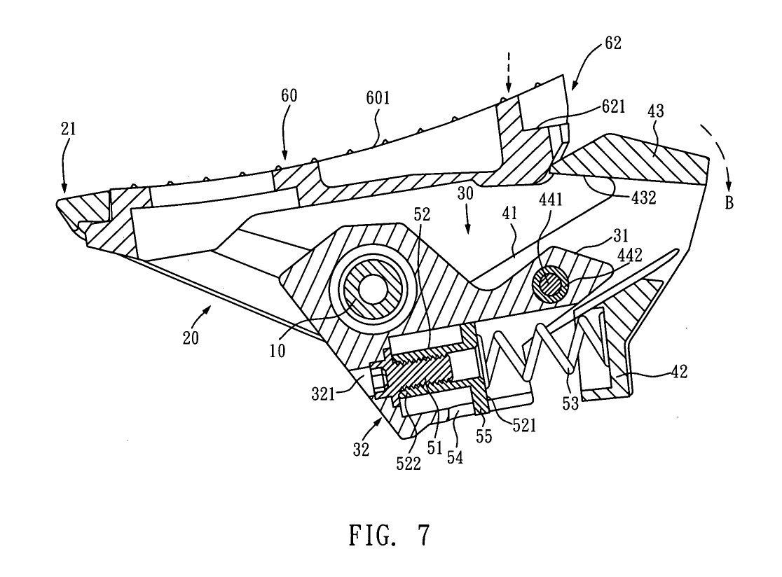

Referring to FIG. 7, the rear coupling portion 62 exerts a downward force to the downward inclined surface 431 of the coupling board 43 so that the fastening member 40 swings around the pin 44 in a direction indicated by arrow B and has its spring-stop portion 42 compressing the compression spring 53, causing the rear coupling portion 62 to pass by the coupling board 43.

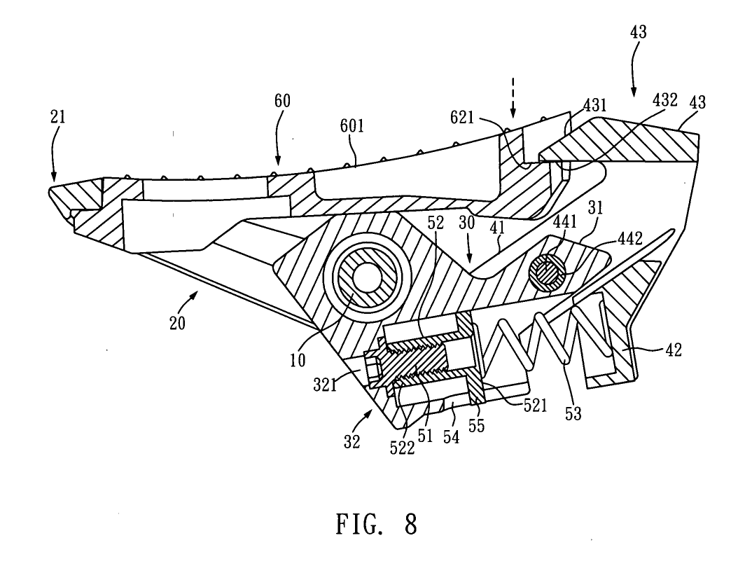

As shown in FIG. 8, the shoe cleat 60 is now coupled with the pedal body 20, and the compression spring 53 restores to abut against the spring-stop portion 42 again, while the horizontal coupling surface 432 of the coupling board 43 and the horizontal coupling surface 621 of the shoe cleat 60 retain mutually.

From the above description, it is learned that the elastic preload of the compression spring 53 determines the clamping force of the coupling board 43 applying to the rear coupling portion 62. When the compression spring 53, after a long period of use, suffers from fatigue failure that weakens the clamping force of the pedal, the clamping force adjusting assembly 50 can be operated to increase the preload of the compression spring 53 so as to recover the due clamping performance of the coupling board 43 providing to the rear coupling portion 62. The elastic preload of the compression spring 53 can be easily adjusted by rotating the adjusting screw 51 in the clamping force adjusting assembly 50 with a screwdriver. Therefore, the clamping force adjusting assembly 50 is easy to operate on a user's own, and allows the user to freely adjust the clamping performance according to his preference.

However, it is to be noted that the best clamping performance relies on the most appropriate clamping force but not the greatest one. The relative contact between the retaining blocks 34 and the open end 412 of the pivot portion 41 prevents the fastening member 40 from excessively swinging toward the shoe cleat 60 and excessively pressing the rear coupling portion 62. Such design, in view of safety, helps to prevent undue engagement between the shoe cleat 60 and the pedal body 20 that obstructs later disassembly.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A bicycle clipless pedal with a clamping force adjusting assembly, the clipless pedal comprising a pedal axle, a pedal body coupled to and rotating around the pedal axle, and a rear clamping set connected to a rear end of the pedal body, wherein the rear clamping set includes:
an assembling portion connected to the pedal body;
a fastening member pivotally connected to the assembling portion;
a compression spring settled in the assembling portion for providing an elastic pushing force to the fastening member; and
the clamping force adjusting assembly deposited at the assembling portion for adjusting a preload of the compression spring.

2. The bicycle clipless pedal with the clamping force adjusting assembly of claim 1, wherein the fastening member comprises:
a pivot portion, having a transversely extending through hole for allowing a pin coupled to the assembling portion to pass therethrough;
a spring-stop portion connected to a lower edge of the pivot portion; and
a coupling board connected from above to the pivot portion.

3. The bicycle clipless pedal with the clamping force adjusting assembly of claim 2, wherein a tubular structure provided at a bottom of the assembling portion has one end corresponding to a spring-stop portion of the pivot portion, and the compression spring has one end distant from the spring-stop portion piercing into the tubular structure.

4. The bicycle clipless pedal with the clamping force adjusting assembly of claim 3, wherein the clamping force adjusting assembly includes an adjusting screw and an adjusting socket, the adjusting socket being linearly movable in the tubular structure, the adjusting socket having a first end formed as a spring-stop portion abutted by the compression spring and a second end provided with a threaded hole, and the adjusting screw coming through a through hole formed at one end of the tubular structure getting screwedly coupled with the threaded hole.

5. The bicycle clipless pedal with the clamping force adjusting assembly of claim 4, wherein a slot and a retaining protuberance are formed at corresponding positions on a wall of the tubular structure and the adjusting socket, respectively, for being coupled mutually.

6. The bicycle clipless pedal with the clamping force adjusting assembly of claim 2, wherein two retaining blocks flank the assembling portion, and an open end of the pivot portion contacts upper surfaces of the retaining blocks.

7. The bicycle clipless pedal with the clamping force adjusting assembly of claim 2, wherein the pin includes a first pin part and a second pin part that are axially combined in a tight fit inside a pin hole of the assembling portion, while outer ends of the first pin part and the second pin part are received in the through hole of the fastening member.
